(19) United States
(12) Patent Application Publication
(10) Pub. No.: US 2026/0328658 A1
(43) Pub. Date: Oct. 22, 2026

(54) METHOD FOR PREPARING CLEARED BIOLOGICAL SPECIMEN

(71) Applicant: KANAZAWA MEDICAL UNIVERSITY, Ishikawa (JP)

(72) Inventor: Toshihisa HATTA, Ishikawa (JP)

(73) Assignee: KANAZAWA MEDICAL UNIVERSITY, Ishikawa (JP)

(21) Appl. No.: 19/113,239

(22) PCT Filed: Sep. 25, 2023
(86) PCT No.: PCT/JP2023/034708

§ 371 Date: Mar. 19, 2025

(30) Foreign Application Priority Data
Sep. 30, 2022 (JP) 2022-157329

(51) Int. Cl. G01N 1/30

(52) U.S. Cl. CPC G01N 1/30

(57) ABSTRACT

An object of the present invention is to provide a method for clearing a biological specimen and a kit for clearing a biological specimen, which enable quick clearing of biological specimens and minimize tissue deformation. According to the present invention, there is provided a method for preparing a cleared biological specimen, comprising the step (1) of treating an object to be cleared, which is a biological specimen, with a clearing and decolorizing solution to obtain the object that has been cleared, wherein the clearing and decolorizing solution contains (a) an acid amide, and (b) one or more selected from the group consisting of benzyl alcohol, glycol ethers and n-butanol. According to the present invention, there is provided a kit for preparing a cleared biological specimen, comprising a clearing and decolorizing solution, wherein the clearing and decolorizing solution contains (a) an acid amide, and (b) one or more selected from the group consisting of benzyl alcohol, glycol ethers and n-butanol.

### TECHNICAL FIELD

### Cross-Reference to Related Application

This application claims conventional priority based on Japanese Patent Application No. 2022-157329, filed Sep. 30, 2022, the entire contents of which are expressly incorporated herein by reference.

The present invention relates to a method for preparing a cleared biological specimen. The present invention relates to a kit for preparing a cleared biological specimen.

### BACKGROUND ART

Techniques for making biological specimens clear are necessary techniques for observing biological specimens and have long been known. In recent years, biological specimens have also been frequently observed by using fluorescent proteins and fluorescent dyes, which have also been used for observation of microscopic tissues such as nerve cells.

The long-established methods for clearing biological specimens include the whole-mount bone staining using alizarin red S, and it is specifically a protocol consisting of (1) digestion of tissues with an alkaline solution or various digestive enzymes (Non-patent document 1), (2) decolorization (differentiation) of the overstained areas with an alkaline solution/glycerol mixture, and (3) gradual replacement with increasing concentrations of glycerol.

In addition, recently developed tissue clearing techniques include Rapid and nondestructive tissue clearing system (RAP, Patent document 1), Scale method and Scale S method (Non-patent documents 2 and 3), SeeDB method (Non-patent documents 4 and 5), CUBIC (Clear, Unobstructed Brain/Body Imaging Cocktails and Computational analysis, Non-patent document 6), CLARITY (Clear Lipid-exchanged Anatomically Rigid Imaging compatible Tissue hYdrogel, Non-patent document 7), 3DISCO (3D Imaging of Solvent-Cleared Organs, Non-patent document 8), iDISCO (Non-patent document 9), and so forth.

Clearing of tissues requires matching of decolorization, degreasing, and refractive index adjustment of the tissues. The main action of most of hydrophobic protocols is matching of degreasing and refractive index adjustment by immersion in a high refractive index solution, and hydrophilic protocols further include hydration in addition to such matching. The hydrophilic protocols mainly utilizing mild hydration action such as Scale and SeeDB cannot provide effective decolorizing action. On the other hand, methods aiming at tissue degreasing action include a method comprising allowing SDS to act on tissues at a high concentration for a long period of time, such as CLARITY, and a method utilizing a strong organic solvent such as tetrahydrofuran and dichloroethane, such as 3DISCO and iDISCO. However, these methods cause deformation of the tissues due to shrinkage and irreversible loss of fluorescent protein activity. Substantially none of the clearing techniques published so far refers to decolorizing action, while deheme action is focused in CUBIC and RAP comprises decolorization of heme and bilirubin.

### PRIOR ART REFERENCES

### Patent Document

Patent document 1: Japanese Patent Application No. 2014-544550 (Japanese Patent No. 6274443)

The entire contents of Patent document 1 are expressly incorporated herein by reference.

### Non-Patent Documents

Non-patent document 1: Dingerkus et al, Stain Technology, 52:229-232, 1977
Non-patent document 2: Hama, H. et al.: Nature Neuroscience, 14, 1481 (2011)
Non-patent document 3: Hama, H. et al.: Nature Neuroscience, 18, 1518 (2015)
Non-patent document 4: Ke et al.: Cell Reports 14, 2718 (2016)
Non-patent document 5: Sakaguchi et al.: eLife 7, e40350 (2018)
Non-patent document 6: E. A. Susaki. et al.: Cell, 157 (3), 726 (2014).
Non-patent document 7: Chung et al., Nature volume 497, pages 332-337 (2013)
Non-patent document 8: Erturk, A., et al. Nat Protoc 7, 1983-1995 (2012)
Non-patent document 9: Renier N., et al. Cell 159, 896-910, Nov. 6, 2014

The entire contents of Non-patent documents 1 to 9 are expressly incorporated herein by reference.

### SUMMARY OF THE INVENTION

### Problems to be Solved by the Invention

The conventional methods for clearing biological specimens suffer from mainly the following problems.
(1) No method capable of providing an action of effectively clearing tissues in a very short time has been reported.
(2) Protocols that provide clearing at a high level cause severe tissue deformation, especially expansion or shrinkage.
(3) Protocols that cause little tissue deformation can provide a low level of clearing.
(4) Methods that can complete clearing in a short time use strong organic solvents, and therefore deactivate activity of fluorescent proteins.
(5) There is no protocol utilizing a hydrophilic solvent that can simultaneously overcome the problems mentioned above.

### Means for Solving the Problems

In view of the aforementioned problems, an object of the present invention is to provide a method for clearing a biological specimen and a kit for clearing a biological specimen, which enable quick clearing of biological specimens and minimize tissue deformation.

The present invention provides the followings.
[1] A kit for preparing a cleared biological specimen, wherein
   the kit comprises a clearing and decolorizing solution, and
   the clearing and decolorizing solution contains
(a) an acid amide, and
(b) one or more selected from the group consisting of benzyl alcohol, glycol ethers and n-butanol.
[2] The kit according to [1], wherein, in the clearing and decolorizing solution, mass-to-volume concentration of (a) the acid amide ranges from 10 to 50 w/v %, and the concentration of (b) one or more selected from the group consisting of benzyl alcohol, glycol ethers and n-butanol ranges from 10 to 70 v/v %.
[3] The kit according to [1] or [2], wherein the clearing and decolorizing solution further contains water.
[4] The kit according to any one of [1] to [3], wherein the clearing and decolorizing solution further contains dimethyl sulfoxide (DMSO).
[5] A method for preparing a cleared biological specimen, comprising the step (1) of treating an object to be cleared, which is a biological specimen, with a clearing and decolorizing solution to obtain the object that has been cleared, wherein the clearing and decolorizing solution contains
(a) an acid amide, and
(b) one or more selected from the group consisting of benzyl alcohol, glycol ethers and n-butanol.
[6] The method according to [5], wherein, in the clearing and decolorizing solution, mass-to-volume concentration of (a) the acid amide ranges from 10 to 50 w/v %, and the concentration of (b) one or more selected from the group consisting of benzyl alcohol, glycol ethers and n-butanol ranges from 10 to 70 v/v %.
[7] The method according to [5] or [6], wherein the object to be cleared is a biological specimen that has been subjected to a staining treatment.
[8] The method according to any one of [5] to [7], which comprises the step of fixing the biological specimen prior to the step (1).
[9] The method according to any one of [5] to [8], wherein the clearing and decolorizing solution further contains water.
[10] The method according to any one of [5] to [9], wherein the clearing and decolorizing solution further contains dimethyl sulfoxide (DMSO).

### Effects of the Invention

The method for preparing a cleared biological specimen of the present invention can have the following advantages.
(1) Clearing of tissues can be performed in a very short time.
(2) It causes little deformation, especially expansion or shrinkage, of tissues.
(3) Clearing can be attained at a high level despite the little deformation of tissues.
(4) Activity of fluorescent protein is not inactivated.
(5) All the advantages mentioned above can be obtained with a protocol using a hydrophilic solvent.

### BRIEF DESCRIPTION OF THE DRAWINGS

FIG. 1 shows effects of decolorization and clearing on 1 mm-thick tissue sections of adult mouse brain.

FIG. 2 shows results of an example in which 10 day-old mouse fetuses were subjected to neurofilament immunostaining, and then a tissue decolorizing and clearing treatment, and observed under a bright field.

FIG. 3 shows results of an example in which 10 day-old mouse fetuses were subjected to neurofilament immunostaining, and then a tissue decolorizing and clearing treatment, and fluorescence was observed.

FIG. 4 shows results of an example in which a brain of a mouse transfected with the tdTomato gene was decolorized and cleared, and an area from the parietal side of the brain to the hippocampus (2 mm deep) was observed with a conventional confocal laser microscope. Blood vessels emitting red fluorescence were observed.

FIG. 5A shows photographs of mouse brain obtained after it was subjected to the reflux fixation, degreasing and decolorizing treatment, and decolorizing and clearing treatment performed in Example 5.

FIG. 5B shows results of measurement of expansion and shrinkage of a brain along the anteroposterior and lateral axes.

FIG. 6 shows results of a decolorizing and clearing experiment performed for a rat neonate (3 days old).

FIG. 7 shows effects of the decolorizing and clearing performed in Example 7 on 1 mm-thick tissue sections of an adult mouse brain.

FIG. 8 shows effects of the decolorizing and clearing performed in Example 8 on 1 mm-thick tissue sections of an adult mouse brain.

### MODES FOR CARRYING OUT THE INVENTION

The explanations of the present invention described below may be made with reference to typical embodiments or specific examples, but the present invention is not limited to them. In this description, numerical value ranges expressed by using “to” means ranges that includes the numerical values mentioned before and after “to” as the lower and upper limits.

### <Method for Preparing Cleared Biological Specimen>

The method for preparing a cleared biological specimen of the present invention comprises at least the following step (1):
the step (1) of treating an object to be cleared, which is a biological specimen, with a clearing and decolorizing solution to obtain the object that has been cleared.

### Step (1)

The clearing and decolorizing solution used in the step (1) contains (a) an acid amide and (b) one or more selected from the group consisting of benzyl alcohol, glycol ethers and n-butanol. The treatment with the clearing and decolorizing solution is performed to make the object to be cleared clear. In this description, the term “clear” means to increase light transparency of the specimen or make the specimen transparent. In this description, the term “decolorize” means to eliminate a color or to make a color disappear. In the method for preparing a cleared biological specimen of the present invention, the specimen is made clear and decolorized at the same time. In this description, the term “cleared” should be understood to also mean a state that transparency of tissues is increased by decolorization. By clearing of the specimen, an effect that tissues and structures located behind or under the portions made clear become visible.

The acid amide is a component for clearing biological tissues and exhibits a clearing action on biological tissues when it is mixed with benzyl alcohol, a glycol ether and/or n-butanol. In one embodiment, the number of carbon atoms of the acid amide is preferably 1 to 5. Examples of the acid amide include, for example, propionamide, acetamide, and formamide, but are not limited to these. The clearing and decolorizing solution can contain one, two, three or more types of acid amides selected from propionamide, acetamide, formamide, and so forth.

Benzyl alcohol is a component for clearing biological tissues and exhibits a clearing action on biological tissues when it is mixed with the acid amide. The glycol ether is a component for clearing biological tissues and exhibits a clearing action on biological tissues when it is mixed with the acid amide. Examples of the glycol ether include, but are not limited to, benzyl glycol, benzyl diglycol, dibenzyl glycol, phenoxyethanol, and so forth.

n-Butanol is a component for clearing biological tissues and exhibits a clearing action on biological tissues when it is mixed with the acid amide. Since n-butanol has a degreasing effect for fats in tissues, a clearing and decolorizing solution containing n-butanol is particularly useful for clearing fatty specimens.

If the acid amide, benzyl alcohol, and glycol ether are used each alone, they scarcely show biological tissue clearing action, and n-butanol shows no clearing action at all when used alone. However, a high clearing effect can be obtained when the acid amide is mixed with benzyl alcohol, a glycol ether, and/or n-butanol. The type and concentration of the acid amide can be appropriately selected within a range suitable for clearing biological tissues. The concentration of benzyl alcohol can be selected within a range suitable for clearing biological tissues. The type and concentration of the glycol ether can be selected within a range suitable for clearing biological tissues. The concentration of n-butanol can be selected within a range suitable for clearing biological tissues. The clearing and decolorizing solution can contain a combination of an acid amide and benzyl alcohol, combination of an acid amide and a glycol ether, combination of an acid amide and n-butanol, combination of an acid amide, benzyl alcohol and a glycol ether, combination of an acid amide, benzyl alcohol and n-butanol, combination of an acid amide, a glycol ether and n-butanol, or combination of an acid amide, benzyl alcohol, a glycol ether and n-butanol.

The acid amide can be dissolved in benzyl alcohol, a glycol ether and/or n-butanol, and a mixture of (a) an acid amide and (b) benzyl alcohol, a glycol ether and/or n-butanol is a liquid. Propionamide and acetamide are solids at room temperature (15 to 25° C.). Formamide is a liquid at room temperature and has a density of 1.134 g/cm³ (25° C.).

As described above, the clearing and decolorizing solution of the present invention can be a mixture of (a) an acid amide and (b) one or more selected from the group consisting of benzyl alcohol, glycol ethers and n-butanol. In the clearing and decolorizing solution, the mixing ratio of the acid amide to one or more selected from the group consisting of benzyl alcohol, glycol ethers and n-butanol can be appropriately determined from the viewpoint of enabling appropriate clearing and decolorization of tissues. The mass-to-volume concentration of the acid amide in the clearing and decolorizing solution can be, for example, in the range of 10 to 50 w/v %, preferably in the range of 20 to 50 w/v %, 30 to 50 w/v %, 40 to 50 w/v %, 25 to 45 w/v %, 12.5 to 50 w/v %, or 13.5 to 25 w/v %. However, it is not intended to be limited to these ranges.

The total concentration of (b) one or more selected from the group consisting of benzyl alcohol, glycol ethers and n-butanol in the clearing and decolorizing solution is, for example, in the range of 10 to 70 v/v %, more preferably 20 to 70 v/v %, 30 to 60 v/v %, 45 to 55 v/v v/v % or 45-50 v/v %. However, it is not intended to be limited to these ranges.

If the clearing and decolorizing solution contains benzyl alcohol, concentration thereof is, for example, in the range of 10 to 70 v/v %, and it can more preferably be in the range of 20 to 70 v/v %, 30 to 60 v/v %, 45 to 55 v/v % or 45 to 50 v/v %. However, it is not intended to be limited to these ranges. If the clearing and decolorizing solution contains a glycol ether, concentration thereof is, for example, in the range of 10 to 70 v/v %, and it can more preferably be in the range of 20 to 70 v/v %, 30 to 60 v/v %, 45 to 55 v/v % or 45 to 50 v/v %. However, it is not intended to be limited to these ranges.

If the clearing and decolorizing solution contains n-butanol, concentration thereof is, for example, in the range of 10 to 70 v/v %, and it can more preferably be in the range of 20 to 70 v/v %, 30 to 60 v/v %, 45 to 55 v/v % or 45 to 50 v/v %. However, it is not intended to be limited to these ranges.

In one embodiment of the present invention, the clearing and decolorizing solution may contain benzyl alcohol and one or more selected from glycol ethers, i.e., two or more types in total. In another embodiment, the clearing and decolorizing solution can contain two or more types of glycol ethers, for example, two or more selected from the group consisting of benzyl diglycol, dibenzyl glycol, and phenoxyethanol. In another embodiment, the clearing and decolorizing solution can contain benzyl alcohol and n-butanol, i.e., two types in total. In another embodiment, the clearing and decolorizing solution can contain n-butanol and one or more types selected from glycol ethers, i.e., two or more types in total. In these embodiments, the total concentration of benzyl alcohol, glycol ether and/or n-butanol in the clearing and decolorizing solution is, for example, in the range of 10 to 70 v/v %, more preferably 20 to 70 v/v %, 30 to 60 v/v %, 45 to 55 v/v %, or 45 to 50 v/v %. However, it is not intended to be limited to these ranges.

The clearing and decolorizing solution used in the present invention can further contain water. That is, the mixture of (a) an acid amide and (b) one or more selected from the group consisting of benzyl alcohol, glycol ethers, and n-butanol can be used as an aqueous solution after adding water. Water may be distilled water, deionized water, or the like. The water can contain a buffering agent such as Tris (tris-hydroxymethylaminomethane). A mixed aqueous solution containing (a) an acid amide, (b) one or more selected from the group consisting of benzyl alcohol, glycol ethers and n-butanol, and water shows high decolorizing action. The concentration of water is in the range of 1 to 80 v/v % of the entire mixed aqueous solution (entire clearing and decolorizing solution), and can preferably be in the range of 1 to 70 v/v %, 1 to 60 v/v %, 1 to 50 v/v %, 1 to 40 v/v %, 1 to 30 v/v %, 1 to 25 v/v %, 1 to 20 v/v %, 1 to 15 v/v %, 1 to 10 v/v %, or 5 to 10 v/v % of the same. When another component such as dimethyl sulfoxide (DMSO) is added, the concentration of water is also in the range of 1 to 80 v/v % of the total mixed aqueous solution, preferably 1 to 70 v/v %, 1 to 60 v/v %, 1 to 50 v/v %, 1 to 40 v/v %, 1 to 30 v/v %, 1 to 25 v/v %, 1 to 20 v/v %, 1 to 15 v/v %, 1 to 10 v/v %, or 5 to 10 v/v % of the same.

The clearing and decolorizing solution used in the present invention preferably has a pH in the range of 8 to 11, but it is not limited to this range. Since a mixture of the components has a pH in the pH range mentioned above, it is not usually necessary to adjust the pH, but the pH can be adjusted if necessary. For the pH adjustment, hydrochloric acid, etc can be used. For example, when a biological specimen transfected with a fluorescent protein gene is cleared and fluorescence is detected, the pH of the clearing and decolorizing solution is preferably adjusted to 10 or lower. When immunostained or fluorescence-labeled specimen is cleared and fluorescence is detected, pH adjustment is not necessary.

A mixed aqueous solution containing (a) an acid amide, (b) one or more selected from the group consisting of benzyl alcohol, glycol ethers and n-butanol, and water can be prepared by first preparing an aqueous acid amide solution and then mixing the aqueous acid amide solution with benzyl alcohol, a glycol ether and/or n-butanol. Alternatively, it may be prepared by further mixing water with a mixture of (a) an acid amide and (b) one or more selected from the group consisting of benzyl alcohol, glycol ethers and n-butanol.

The clearing and decolorizing solution used in the present invention can further contain dimethyl sulfoxide (DMSO). That is, a mixture obtained by adding dimethyl sulfoxide to a mixture of (a) an acid amide and (b) one or more selected from the group consisting of benzyl alcohol, glycol ethers and n-butanol can be used. The addition of dimethyl sulfoxide provides further higher clearing action. The concentration of dimethyl sulfoxide can be in the range of 1 to 10 v/v % of the total mixed solution of (a) an acid amide and (b) one or more selected from the group consisting of benzyl alcohol, glycol ethers and n-butanol. When dimethyl sulfoxide is added to such a mixed aqueous solution as mentioned above, the concentration thereof can also be in the range of 1 to 10 v/v % of the total mixed aqueous solution.

The clearing and decolorizing solution used in the present invention can further contain a surfactant. Examples of such a surfactant include Triton (registered trademark) X-100 (octylphenol poly(ethylene glycol ether)ₙ, n is about 10, HLB is 13.4 to 13.5), Tween (registered trademark) 20 (polysorbate 20, monolauric acid polyoxyethylene sorbitan, HLB is 16.7), NP40, sodium deoxycholate, etc. The concentration of the surfactant can be in the range of 0.01 to 1 v/v %, preferably in the range of 0.01 to 0.5 v/v %, or 0.01 to 0.2 v/v %, of the clearing and decolorizing solution. The inventor of the present invention has found that the clearing and decolorizing solution containing 0.01 v/v % sodium deoxycholate or 0.08 v/v % NP40 has an effect of suppressing expansion of biological specimens or shrinking expanded biological specimens to restore them.

The treatment of an object to be cleared with the clearing and decolorizing solution is performed by, for example, immersing the object to be cleared in a predetermined volume (at least such a volume that the entire object to be cleared is submerged in the clearing and decolorizing solution) of the clearing and decolorizing solution at room temperature (e.g., 5 to 35° C., preferably 15 to 30° C., the same shall apply hereafter) or at a temperature in the range of from room temperature to 42° C., for a period in the range of 1 hour to 2 weeks, preferably 1 to 10 days, or 1 to 24 hours, more preferably 2 to 12 hours. Although a higher temperature tends to complete the treatment in a shorter time, there is a risk of greater damage to the tissue depending on the type of the object to be cleared, and therefore the treatment temperature is preferably adjusted as appropriate with taking this into consideration. In a specific embodiment where a fatty tissue specimen is treated with a clearing and decolorizing solution containing n-butanol, the treatment at a temperature of 42 and 52° C. provides a high degreasing effect, and the tissue specimen can be thereby made more clear. However, the above temperatures and times are mentioned only for exemplification, and the temperature and time are not intended to be limited to these ranges.

The method for preparing a cleared biological specimen of the present invention enables clearing of tissues in a very short time. Although the treatment time varies depending on thickness of the biological specimen and type of tissue, clearing of tissues can be achieved within one hour for sections having a thickness of 1 to 3 mm. The method for preparing a cleared biological specimen of the present invention causes little deformation, especially expansion or shrinkage, of tissue. The tissue deformation rate is 5% or less. The rate of tissue deformation can be calculated by measuring the size of the object to be cleared before and after immersion in the clearing and decolorizing solution (e.g., length of the long axis, width, and height of the specimen). The method for preparing a cleared biological specimen of the present invention causes less tissue deformation, but provides higher clearness. The method for preparing a cleared biological specimen of the present invention does not deactivate activities of fluorescent proteins. The clearing and decolorizing solution does not contain organic solvents, and therefore plastic containers can be used for the treatment.

The biological specimen as the object to be cleared referred to in this description is not particularly limited, and can be, for example, a fish, amphibian, reptile, or mammal (excluding humans when the specimen is the whole organism). The biological specimen can also be a living tissue, and can be any tissue of a living body, e.g., internal organ, blood vessel, nerve, brain, or bone. Technically, clear specimens of human organs can also be prepared, and in such cases, for example, it is appropriate to take ethical considerations into account, for example, to obtain approval from an ethics committee. However, these are mere examples, and the specimen is not limited as long as the specimen is a biological specimen. However, from the viewpoint that clearing is easily attained by a treatment with the clearing and decolorizing solution, the specimen can be a fish, amphibian, bird, mammal, or a tissue thereof.

The biological specimen as the object to be cleared can have been subjected beforehand to staining, immunostaining, or a treatment for labeling, such as introduction of a gene encoding a fluorescent protein. The label is not particularly limited, and the specimen can be labeled with a fluorescent dye, fluorescent protein, or enzyme. As the fluorescent dye, fluorescein isothiocyanate (FITC), rhodamine, Texas red, Cy3, Cy5 etc. can be used, but it is not limited to these. As the fluorescent protein, phycoerythrin (PE), allophycocyanin (APC), green fluorescent protein (GFP), tdTomato red fluorescent protein etc. can be used, but it is not limited to these. As the enzyme, horseradish peroxidase (HRP), alkaline phosphatase, glucose oxidase etc. can be used, but it is not limited to these. Labeling can be performed via an antibody or antibody fragment that binds to a specific tissue or specific substance (protein, nucleic acid, metabolite etc.) in living organisms.

The biological specimen as the object to be cleared can be one introduced with a fluorescent protein gene by genetic recombination. Since fluorescent proteins require water for their activity, the clearing and decolorizing solution preferably contain water. The concentration of water is as described above.

The biological specimen as the object to be cleared can be fixed beforehand. For the fixation, formaldehyde, paraformaldehyde, ethanol, methanol, acetone, etc. can be used. The fixation can be performed at a temperature of from 4° C. to room temperature. The fixing solution described in Japanese Patent No. 6274443 can be used. The fixing solution described in Japanese Patent No. 6274443 is (a) an aqueous solution containing formaldehyde or paraformaldehyde, a nonionic surfactant, an alkali and a buffering agent, or (b) an aqueous solution containing formaldehyde or paraformaldehyde, a nonionic surfactant and an alkali.

After a treatment with a fixing solution, the biological specimen as the object to be cleared can be washed beforehand. For washing, distilled water or buffer solution can be used. Such washing can be performed at room temperature.

The biological specimen fixed and washed beforehand can be pretreated with 50 v/v % dimethyl sulfoxide or 50 v/v % ethylene glycol. This pretreatment can be performed at a temperature of from 4° C. to room temperature for 1 to 24 hours.

The biological specimen as the object to be cleared can also be, if necessary, subjected to a treatment for bleaching, degreasing or bleaching and degreasing after the treatment with a fixing solution and washing. For bleaching, for example, hydrogen peroxide, acetone or ethanol can be used. For degreasing, for example, acetone or ethanol and chloroform can be used. For example, degreasing using chloroform can be performed by immersing the specimen in an equal volume mixture of formamide, benzyl alcohol, and chloroform.

In the method for preparing a cleared biological specimen, by the treatment of the object to be cleared with the clearing and decolorizing solution, the object that has been cleared can be obtained. The resulting cleared biological specimen can be used as it is for the following, for example, observation. However, depending on the type of the object to be cleared, clearing may not be sufficient. For such an object to be cleared, the clearing can be further enhanced by immersion in a solvent with a high refractive index, such as thiodiethanol (TDE) or a mixture of benzyl alcohol and benzyl benzoate (BABB),

### <Kit for Preparing Cleared Biological Specimen>

The kit for preparing a cleared biological specimen of the present invention includes a clearing and decolorizing solution. This clearing and decolorizing solution is the same as that described for the above method for preparing a cleared biological specimen.

The kit of the present invention is used for the method for preparing a cleared biological specimen of the present invention as appropriate.

The clearing and decolorizing solution included in the kit of the present invention can further contain water. The clearing and decolorizing solution included in the kit of the present invention can contain dimethyl sulfoxide (DMSO). The clearing and decolorizing solution included in the kit of the present invention can contain a surfactant. The concentrations and types of water, dimethyl sulfoxide (DMSO), and surfactant are the same as those described above for the method for preparing a cleared biological specimen.

The kit of the present invention can further include a container for storing the clearing and decolorizing solution, label and/or instructions. The clearing and decolorizing solution can be included in the kit in a state that it is stored in a container. Examples of the container include, but are not limited to, bottles, tubes, conical tubes, vials, bags, etc. The container can be made from various types of materials, e.g., glass or plastics. How to use the kit can be described on the label and/or instructions.

The kit of the present invention can include a container storing a mixture of (a) an acid amide and (b) one or more selected from the group consisting of benzyl alcohol, glycol ethers and n-butanol, and a container storing water. At the time of use, the user of the kit can mix the mixture with water according to the type or purpose of the object to be cleared.

The kit of the present invention may provide the components of the clearing and decolorizing solution separately, and in such a case, the user of the kit can mix those components at the time of use. That is, the kit of the present invention may separately include one or more selected from the group consisting of benzyl alcohol, glycol ethers and n-butanol, acid amide, water, and dimethyl sulfoxide (DMSO). Specifically, the kit of the present invention may include a container storing an acid amide, a container storing one or more selected from the group consisting of benzyl alcohol, glycol ethers and n-butanol, a container storing water, and a container storing dimethyl sulfoxide (DMSO). How to use the kit and mixing ratios of the components can be described on the labels and/or instructions.

### EXAMPLES

The present invention will be more specifically explained with reference to the following examples, but the present invention is not limited to these examples.

### Example 1

### Clearing of Mouse Brain 1

As the specimen, 1-mm thick sections of the cerebrum of 10-week old male ICR mouse were used.

### (1) Fixation

4% Phosphate-buffered paraformaldehyde
Room temperature, 1 hour to overnight

### (2) Washing

Phosphate-buffered saline (PBS, pH 7.2 to 7.4)
Room temperature, 30 minutes

### (3) Pretreatment

50 v/v % Dimethyl sulfoxide
Room temperature, 30 minutes to 1 hour

### (4) Clearing and Decolorizing Solution:

Clearing and decolorizing solution

| | |
|---|---|
| 6M (27.0 w/v %) aqueous formamide solution | 5 volumes |
| Benzyl alcohol | 5 volumes |

Room temperature, 1 hour

### Results

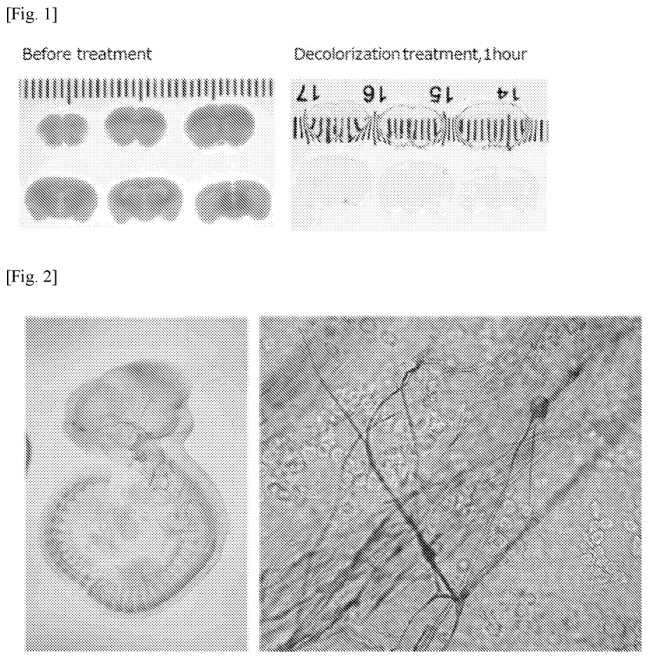

The results are shown in FIG. 1. Conventional clearing treatment methods require about one to several days to complete clearing (not including fixation time). With the method of the present invention, decolorization and a high degree of clearing can be completed in a very short time (about 1 hour).

### Example 2

### Example of Clearing of Whole Body of Mouse Fetus (10 Days Old) Subjected to Neurofilament Immunostaining and Bright Field Observation Thereof.

As the specimen, whole bodies of fetal mice (fetal age, 10 days) were used. The crown rump lengths were 4 to 5 mm.

### Preparation

### (1) Fixation

4% Phosphate-buffered paraformaldehyde
Room temperature, 1 hour to overnight

### (2) Washing

Phosphate-buffered saline (PBS, pH 7.2 to 7.4)
Room temperature, 30 minutes

### Immunostaining

### (3) Bleaching

6% Hydrogen peroxide and methanol mixture
Room temperature, 1 hour

### (4) Washing

100% methanol
Room temperature, liquid exchange (20 ml of 100% methanol) for about 5 minutes×3 times

### (5) Pretreatment for Immunostaining (Treatment for Promoting Antibody Penetration)

2.5 v/v % Triton (registered trademark) X-100, dimethyl sulfoxide-methanol equal volume mixture
Room temperature, 30 minutes

### (6) Washing

Tris-buffered saline supplemented with 0.5% Triton (registered trademark) X-100 (TBST, pH 7.2 to 7.4)
Room temperature, 30 minutes to 1 hour

### (7) Blocking

5 g/v % Skim milk, TBST
Room temperature, 6 hours
   (8) Primary antibody
Anti-neurofilament antibody, TBST
4° C., Overnight

### (9) Washing

TBST
Room temperature, 1 hour×8 times

### (10) Secondary Antibody

HRP (horseradish peroxidase)-labeled secondary antibody, 5 w/v % skim milk, TBST
4° C., Overnight

### (11) Color Development

0.025 g/v % 3,3′-Diaminobenzidine, TBST (DAB solution, serving as the substrate for HRP)
Ice temperature, 30 minutes

### (12) Color Development

0.003 v/v % Hydrogen peroxide, DAB solution
Ice temperature, 15 minutes

### (13) Washing

TBST
Room temperature, 1 hour×8 times

### (14) Post-Fixation

4% Phosphate-buffered paraformaldehyde
Room temperature, at least 1 hour

### (15) Washing

Phosphate buffered saline (PBS, pH 7.2 to 7.4),
Room temperature, 30 minutes

### Decolorization and Clearing

### Pretreatment

50 v/v % Dimethyl sulfoxide
Room temperature, 30 minutes to 1 hour

### Clearing and Decolorizing Solution:

| | | |
|---|---|---|
| 6M (43.9 w/v %) Propionamide aqueous solution | 5 | volumes |
| Benzyl alcohol | 5 | volumes |
| Dimethyl sulfoxide | 1 | volume |
| Triton (registered trademark) X100 | 1/1000 | volume |

Room temperature, overnight

### Results

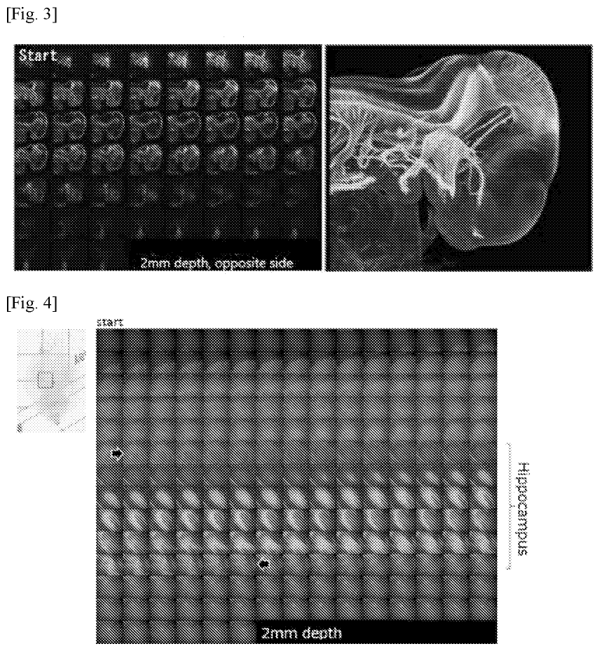

The results are shown in FIG. 2. Conventional clearing treatment methods require about several days to one week to complete clearing (not including fixation time). With the method of the present invention, the whole bodies became transparent like glass after one night of the treatment, and neurofilaments stained with HRP (yellow) could be observed. In addition, the method of the present invention is characterized by minimal deformation due to shrinkage.

### Example 3

### Example of Clearing of Whole Body of Mouse Fetus (Fetal Age, 10 Days) Subjected to Neurofilament Immunostaining and Bright Field Observation Thereof.

As the specimen, whole bodies of fetal mice (fetal age, 10 days) were used. The crown rump lengths were 4 to 5 mm.

### (1) Fixation

4% Phosphate-buffered paraformaldehyde
Room temperature, 1 hour to overnight

### (2) Washing

Phosphate buffered saline (PBS, pH 7.2 to 7.4)
Room temperature, 30 minutes

### Immunostaining

### (3) Bleaching

6% Hydrogen peroxide and methanol mixture
Room temperature, 1 hour

### (4) Washing

100% methanol
Room temperature, several times

### (5) Pretreatment for Immunostaining (Treatment to Promote Antibody Penetration)

2.5 v/v % Triton (registered trademark) X-100, dimethyl sulfoxide-methanol equal volume mixture
Room temperature, 30 minutes

### (6) Washing

Tris-buffered saline supplemented with 0.5% Triton (registered trademark) X-100 (TBST, pH 7.2 to 7.4)
Room temperature, 30 minutes to 1 hour

### (7) Blocking

5 g/v % Skim milk, TBST
Room temperature, 6 hours
   (8) Primary antibody
Anti-neurofilament antibody, TBST
4° C., Overnight

### (9) Washing

TBST
Room temperature, 1 hour×8 times

### (10) Secondary Antibody

FITC (fluorescein isothiocyanate)-labeled secondary antibody, 5 w/v % skim milk, TBST
4° C., Overnight

### (11) Washing

TBST
Room temperature, 1 hour×8 times

### (12) Post-Fixation

4% Phosphate-buffered paraformaldehyde
Room temperature, at least 1 hour

### (13) Washing

Phosphate buffered saline (PBS, pH 7.2 to 7.4),
Room temperature, 30 minutes

### Decolorization and Clearing

### Pretreatment

50 v/v % Dimethyl sulfoxide and 0.1 M Tris mixture
Room temperature, 30 minutes to 1 hour

### Clearing and Decolorizing Solution (Mixture of the Following Solutions A, B, and C)

| | |
|---|---|
| Solution A | 9 volumes |

40 w/v % Acetamide aqueous solution
15 v/v % Triton X-100
5 v/v % Ethylene glycol
5 v/v % DMSO
1 w/v % Sucrose

| | |
|---|---|
| Solution B | 2 volume |

Benzyl diglycol (diethylene glycol monobenzyl ether)

| | |
|---|---|
| Solution C | 1 volume |

2 M Tris aqueous solution (Trizma base aqueous solution)
37° C., Overnight

### Solvent for Observation

| | |
|---|---|
| Phenoxyethanol | 6 volumes |
| DMSO | 2 volumes |
| 0.2M Tris solution | 2 volumes |

37 °C, One to several hours

### Results

The results are shown in FIG. 3. Conventional clearing treatment methods require about several days to one week to complete clearing (not including fixation time). With the method of the present invention, the whole bodies became transparent like glass after one night of the treatment, and neurofilaments stained with FITC (green fluorescence) could be observed. In addition, the method of the present invention is characterized by minimal deformation due to shrinkage. The fetuses could be observed up to the contralateral side (2 mm deep) with an ordinary confocal laser microscope.

### Example 4

### Clearing of VE-Cadherin-tdTomato-Introduced Red Blood Vessel Adult Mouse Brain

The VE-cadherin-tdTomato-introduced red blood vessel mice were obtained by introducing a fusion gene of the gene encoding VE-cadherin, an adhesion-binding molecule of vascular endothelial cells, and the gene for tdTomato, a red fluorescent protein, incorporated into a gene transduction vector, into mice. The mice were kindly provided by Professor Hideto Yonekura, Department of Biochemistry II, Kanazawa Medical University.

### (1) Fixation

4% Paraformaldehyde
5 v/v % Triton X-100
5% Diethylene glycol
0.05 M Tris aqueous solution (Trizma base aqueous solution)
Room temperature, overnight (the fixing solution was changed every day until the solution was no longer colored)

### (2) Washing

Phosphate-buffered saline (PBS, pH 7.2 to 7.4)
Room temperature, 30 minutes to 1 hour

### (3) Decolorization and Clearing

### Pretreatment

10 v/v % Triton X-100
10 v/v % Diethylene glycol
1 M Tris aqueous solution (Trizma base aqueous solution)
Room temperature, 1 day (stored at 4° C. until the experiment was started)

### Clearing and Decolorization

The specimens were treated with the clearing and decolorizing solution (1) or (2).

### Clearing and Decolorizing Solution (1)

| | |
|---|---|
| 50 w/v % (8.46M) Acetamide, 1.5M Tris | 1 volume |
| aqueous solution (Trizma base solution) | |
| n-Butanol | 1 volume |

Room temperature to 52 °C, 2 days

### Clearing and Decolorizing Solution (2)

| | | |
|---|---|---|
| 50 w/v % (8.46M) Acetamide, 1.5M Tris | 3 | volumes |
| aqueous solution (Trizma base solution) | | |
| n-Butanol | 3.5 | volumes |
| Phenoxyethanol | 3.5 | volumes |

Room temperature to 52 °C, 6 days

### Solvent for Observation

| | | |
|---|---|---|
| 45 w/v % (6.12M) Propionamide, 0.1M Tris | 5 | volumes |
| aqueous solution (Trizma base solution) | | |
| Phenoxyethanol | 5 | volumes |
| Benzyl glycol | 1 | volume |
| Triton X-100 | 1/1000 | volume |

42 °C, at least 1 day

### Results

The results are shown in FIG. 4.

The decolorization and clearing of the adult mouse cerebrums take approximately 10 days to 2 weeks. Whereas the gray matters in the deep cerebrum could not be sufficiently cleared by the conventional aqueous clearing protocols, such as the Scale and Cubic methods, the gray matters could be cleared by the method of the present invention (FIG. 4). In this example, the clearing and decolorizing solutions contained n-butanol, and it is thought that the gray matters were cleared by the degreasing effect of n-butanol. Even when the n-butanol-containing clearing and decolorizing solutions were used, the activity of the fluorescent protein was retained, and observation of deep parts was possible. FIG. 4 shows the results of an exemplary observation of the cerebrums from the parietal side to the hippocampus (2 mm depth) using a conventional confocal laser microscope. The clearing and decolorizing solution (1) shows a strong degreasing effect, and the clearing and decolorizing solution (2) shows a strong decolorizing effect. FIG. 4 shows photographs of brains treated with the clearing and decolorizing solution (1).

### Example 5

### Action for Inhibiting Morphological Change Accompanying Clearing

In this example, expansion and shrinkage of the specimen were prevented by adjusting the composition of the decolorizing and clearing solution.

### Reflux Fixation

4% Phosphate-buffered paraformaldehyde (pH 7.4), 4° C., overnight

### Decolorizing and Clearing Treatment 1 (Degreasing and Decolorization)

| | |
|---|---|
| A: Benzyl glycol | 6 volumes |
| B: 25 w/v % Acetamide, 15 v/v % Triton X-100, | 4 volumes |
| 5 v/v % DMSO, 0.05M Tris aqueous solution | |

Shaking in a mixture of A and B, room temperature, 2 to 3 days

### Decolorizing and Clearing Treatment 2 (Decolorizing and Clearing)

| | | |
|---|---|---|
| A: Phenoxyethanol | 2 | volumes |
| B: Benzyl glycol | 1 | volume |
| C: 50 w/v % Acetamide, 0.1M Tris aqueous solution | 3 | volumes |
| D: NP40 | 1/20 | volume |

After the decolorizing and clearing treatment 1, shaking in a mixture of A, B, C and D, 42° C., 2 days (1 to 2 days)

### Results

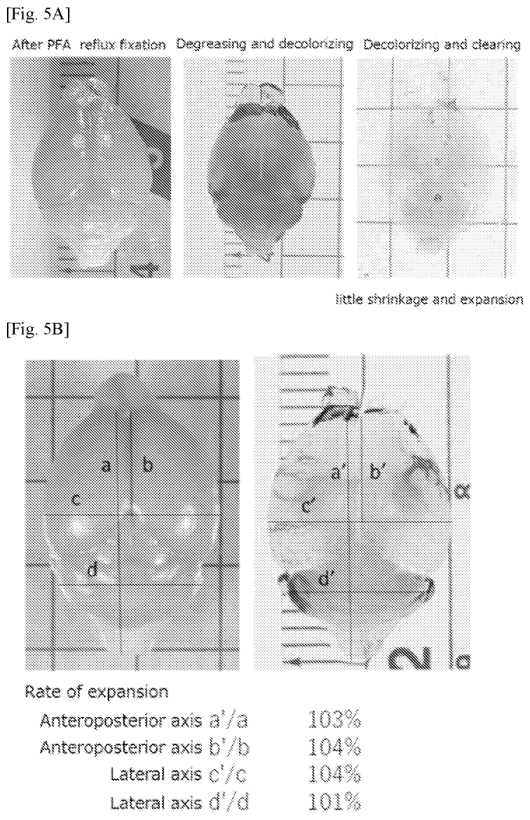

The tissue decolorizing and clearing method of the present invention is characterized by minimal deformation and shrinkage of the biological specimen after completion of the clearing. FIG. 5 shows the results of measurements of expansion and shrinkage of the brain in the anteroposterior and lateral axes, showing very little expansion and deformation, although expansion of less than 5% could be observed.

### Example 6

3 Day-Old Rat Neonate Subjected to Decolorizing and Clearing with Hair, Skin and Internal Organs Remained Intact

The specimen was a 3 day-old rat neonate with hair, skin, and internal organs remained intact. The head torso length was 27 mm.

### (1) Fixation

2% Phosphate-buffered formaldehyde (paraformaldehyde), 5 v/v % Triton (registered trademark) X-100, and 1 w/v % potassium hydroxide mixture
42° C., 1 to 7 Days (the fixing solution was changed every day until the solution was no longer colored)

### (2) Washing

Distilled water
Room temperature, 1 to 3 hours

### (3) Decolorization and Clearing

### Pretreatment

50 v/v % Dimethyl sulfoxide
Room temperature, 30 minutes to 1 hour

### Clearing and Decolorizing Solution:

| | | |
|---|---|---|
| 6M (43.9 w/v %) Propionamide, 0.1M Tris | 5 | volumes |
| aqueous solution | | |
| Phenoxyethanol | 5 | volumes |
| Dimethyl sulfoxide | 1 | volume |
| Triton (registered trademark) X100 | 1/100 | volume |

Room temperature, 1 to 3 days

### Results

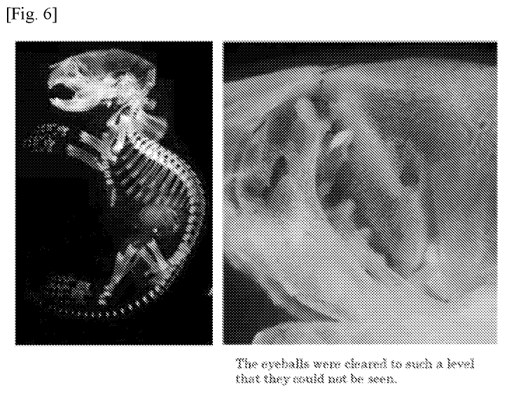

The results are shown in FIG. 6. Non-destructive and complete clearing could be achieved in a very short time, leaving all of body hair, skin, soft tissues including muscles, and internal organs retained intact. Even without staining, the microstructures of bone could be observed in high definition, and the eyeballs were cleared to such a level that they could not be seen (FIG. 6, right). No technique has been reported to date to achieve such a high level of clearing of such a large specimen in a short time and nondestructive manner.

### Example 7

### Clearing of Mouse Brain 2

The specimens were 1-mm sections of the cerebrums of 10-week old male ICR mice.

### (1) Fixation

4% Phosphate-buffered paraformaldehyde/0.1 M phosphate buffer
Room temperature, 1 hour to overnight

### (2) Washing

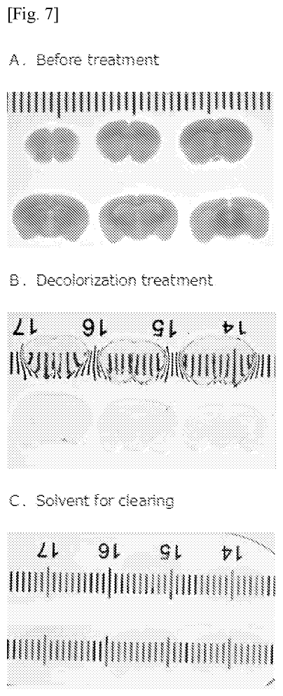

0.1 M Phosphate-buffered saline (PBS, pH 7.2 to 7.4)
Room temperature, 30 minutes
   (3) Treatment with Clearing and Decolorizing Solution
Clearing and decolorizing solution (BA/FA): 1 volume of benzyl alcohol, and 1 volume of formamide
Immersion for 1 hour at room temperature with shaking. Photographs of the sections after the decolorization are shown in FIG. 7B.

### (4) Degreasing

Formamide:benzyl alcohol:chloroform=1:1:1 by volume
20° C., Overnight

### (5) Washing

Equal volume mixture of ethylene glycol and acetone
Immersion for 30 minutes twice
   (6) Treatment with Solvent for Observation

As the solvent for observation, the following solutions A, B, and C were mixed before use.
Solution A: Mixture of 5 volumes of benzyl alcohol, 2 volumes of phenoxyethanol, 1 volume of DMSO, and 1 volume of glycerol, 5 mL
Solution B: 8.5 M (50 w/v %) Acetamide aqueous solution, 500 μL
Solution C: 0.1 M Sodium benzoate solution, 50 μL

### Results

The results are shown in FIG. 7. As shown in FIG. 7B, decolorization and a high level of clearing were completed in a very short time (about 1 hour) by the method of the present invention. FIG. 7C shows a photograph of sections immersed in the solvent for observation. Transparency was further increased by immersion in the solvent for observation of which refractive index was controlled.

### Example 8

### Clearing of Mouse Brain 3

For the samples, ICR mice were used.

The mice were subjected to reflux fixation in 10% phosphate-buffered formalin, then the brains were extracted and fixed in 10% phosphate-buffered formalin, and 1-mm thick sections were prepared.

### Pre-Incubation:

The sections were immersed overnight in 25% ethylene glycol/phosphate buffer.

The sections were immersed in a solution having the following composition (1) or (2) as the clearing and decolorizing solution overnight at 42° C.

### (1) Clearing and Decolorizing Solution (PhE/PA)

| | |
|---|---|
| Phenoxyethanol | 5 mL |
| 6M Propionamide aqueous solution | 5 mL |
| DMSO | 1 mL |

### (2) Clearing and Decolorizing Solution (PhE/AA)

| | |
|---|---|
| Phenoxyethanol | 5 mL |
| 6M Acetamide aqueous solution | 5 mL |
| DMSO | 1 mL |

### Results

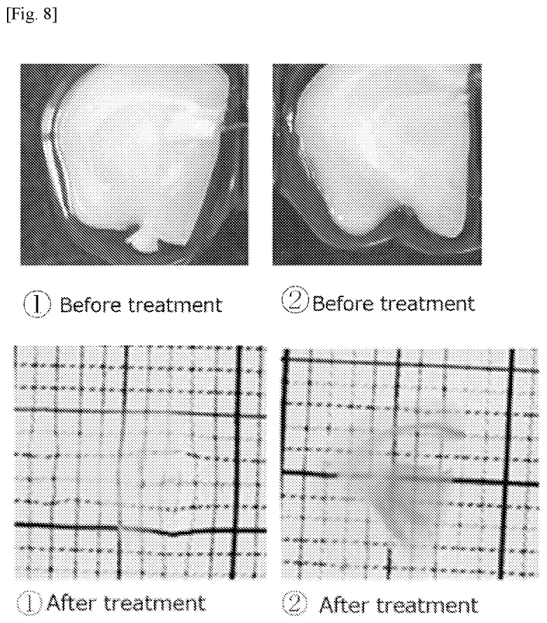

The results are shown in FIG. 8. Decolorizing and clearing were completed in a very short time (overnight) by the method of the present invention.

### INDUSTRIAL APPLICABILITY

The present invention is useful in fields where observation of living organisms or biological tissues is required, such as medicine and biology.

1. A kit for preparing a cleared biological specimen, wherein the kit comprises
a clearing and decolorizing solution, and
the clearing and decolorizing solution contains
(a) an acid amide, and
(b) one or more compounds selected from the group consisting of benzyl alcohol, benzyl glycol, benzyl diglycol, dibenzyl glycol, phenoxyethanol and n-butanol.

2. The kit according to claim 1, wherein, in the clearing and decolorizing solution, a mass-to-volume concentration of (a) the acid amide ranges from 10 to 50 w/v %, and the concentration of (b) the one or more compounds selected from the group consisting of benzyl alcohol, benzyl glycol, benzyl diglycol, dibenzyl glycol, phenoxyethanol and n-butanol ranges from 10 to 70 v/v %.

3. The kit according to claim 1, wherein the clearing and decolorizing solution further contains water.

4. The kit according to claim 1, wherein the clearing and decolorizing solution further contains dimethyl sulfoxide (DMSO).

5. A method for preparing a cleared biological specimen, comprising a step of
(1) treating a biological specimen to be cleared, with a clearing and decolorizing solution to obtain a cleared biological specimen, wherein the clearing and decolorizing solution contains
(a) an acid amide, and
(b) one or more compounds selected from the group consisting of benzyl alcohol, benzyl glycol, benzyl diglycol, dibenzyl glycol, phenoxyethanol and n-butanol.

6. The method according to claim 5, wherein, in the clearing and decolorizing solution, a mass-to-volume concentration of (a) the acid amide ranges from 10 to 50 w/v %, and a concentration of (b) the one or more compounds selected from the group consisting of benzyl alcohol, benzyl glycol, benzyl diglycol, dibenzyl glycol, phenoxyethanol and n-butanol ranges from 10 to 70 v/v %.

7. The method according to claim 5, wherein the biological specimen is a biological specimen that has been subjected to a staining treatment.

8. The method according to claim 5, further comprising a step of fixing the biological specimen prior to the step (1).

9. The method according to claim 5, wherein the clearing and decolorizing solution further contains water.

10. The method according to claim 5, wherein the clearing and decolorizing solution further contains dimethyl sulfoxide (DMSO).

11. The kit according to claim 2, wherein the clearing and decolorizing solution further contains water.

12. The kit according to claim 2, wherein the clearing and decolorizing solution further contains dimethyl sulfoxide (DMSO).

13. The method according to claim 6, wherein the biological specimen is a biological specimen that has been subjected to a staining treatment.

14. The method according to claim 6, further comprising a step of fixing the biological specimen prior to the step (1).

15. The method according to claim 6, wherein the clearing and decolorizing solution further contains water.

16. The method according to claim 6, wherein the clearing and decolorizing solution further contains dimethyl sulfoxide (DMSO).
